(19) United States
(12) Patent Application Publication
(10) Pub. No.: US 2002/0122316 A1
(43) Pub. Date: Sep. 5, 2002

(54) Full circle illumination band

(76) Inventor: Oliver Hsieh, HsiChih City (TW)

Correspondence Address: JASON Z. LIN, 19597 Via Monte Drive, Saratoga, CA, 95070, US

(21) Appl. No.: 09/798,524

(22) Filed: Mar. 3, 2001

(51) Int. Cl. F21V 21/08; F21V 8/00

(52) U.S. Cl. 362/570; 362/103; 362/104; 362/108

(57) ABSTRACT

A full circle illumination band comprises an illumination device and a power-supply unit inside a housing, wherein two ends of a light-guiding core meet each other at the housing. In operation, light is emanated from one end of the housing to reach the other end of the same through the light-guiding cord and brighten the entire illumination band.

### FIELD OF THE INVENTION

This invention relates generally to an illumination neckband, more particularly, it relates to a full circle illumination band that uses only few amount of illumination element with an associated light-guiding cord to enable the incident light emitted from the illumination element to go through one end of the transparent solid cord and fully lighten the entire illumination band so as to show its splendor with lower production cost, and moreover, the light-guiding cord may be cut at will unlike what is limited in the electronic circuit of a conventional hollow cord, namely, “DIY” in length is possible.

### BACKGROUND OF THE INVENTION

As illustrated in FIG. 4, in a conventional illumination neckband hitched on a pet, an electric wire D1 is penetratingly arranged in a transparent flexible tube C and a plurality of lighting elements D (mostly LEDs) is disposed on the wire D1. Two ends of the tube C are jointed with a coupling B and a power supply A individually which are in connection with two ends of the wire D1 respectively, wherein the coupling B is extended to form a flat band B1 provided with a row of punched holes B11. The power supply A is provided internally with a cell pack and electronic components and externally with a plurality of protrusions Al to each thereof a head A11 with a slightly larger diameter than that of the protrusion body as well as the punched hole B11 is provided.

When using the conventional illumination neckband, a pet's master is supposed to lay the tube C on his pet's neck firstly, then force the head A11 to go through the punched hole B11 in the flat band B1 such that the head A11 can be retained in the hole B11 to prevent the protrusion A1 from escaping. After power is supplied, the lighting elements D emanate light to have the neckband become brilliant.

However, there still are some defects found in the conventional illumination neckband as below:

1. When the neckband is lightened, a plurality of light sources is formed in the tube to show merely the spotlight effect instead of full circle illumination effects and become eyesores to people.

2. Many lighting elements are required, and the non-standardized customer orders, including different styles, measurements, and circuit specifications, would raise the cost of production.

3. After the band is fixed at the protrusions, some unfastened portion of the band would expose to the air in an unsightly manner, which may be dragged by the pet itself or a kid to be detached from the protrusions.

### SUMMARY OF THE INVENTION

The primary object of this invention is to provide a full circle illumination band, which takes a transparent light-guiding cord as a light transmission medium such that light appears at the other end with a soft and beautiful visual effect.

Another object of this invention is to provide a full circle illumination band that requires only few amount of light element to have achieved light-transmission purpose so as to reduce cost.

Yet another object of this invention is to provide a full circle illumination band, which, after connection of two ends of a transparent light-guiding cord, will expose no extra part thereof so as to keep intactness of the band and prevent it from being dragged to get detached by a pet itself or a kid, and moreover, the length of the light-guiding cord could be cut at will in DIY manner.

In order to realize abovesaid objects, an illumination device and a power-supply unit are disposed in a housing unit of this invention, wherein two ends of a light-guiding core meet each other at the housing. In operation, light is emanated from one end of the housing to reach the other end of the same through the light-guiding cord.

For more detailed information regarding this invention together with advantages or features thereof, at least an example of preferred embodiment will be elucidated below with reference to the annexed drawings.

### BRIEF DESCRIPTION OF THE DRAWINGS

FIG. 1 is an exploded view in three dimensions showing the main components of this invention.

FIG. 2 is a cutaway sectional view showing the structure of this invention.

FIG. 3 shows an embodiment of hitching a full circle band of this invention on a pet's neck.

FIG. 4 is a structural view in three dimensions of a conventional illumination neckband.

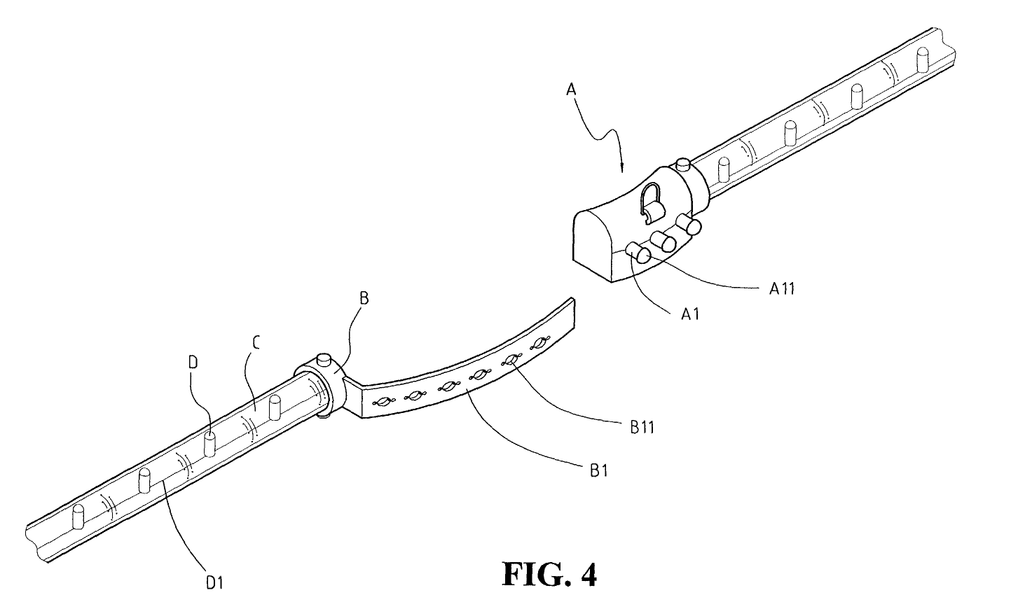

### DETAILED DESCRIPTION OF THE PREFERRED EMBODIMENT

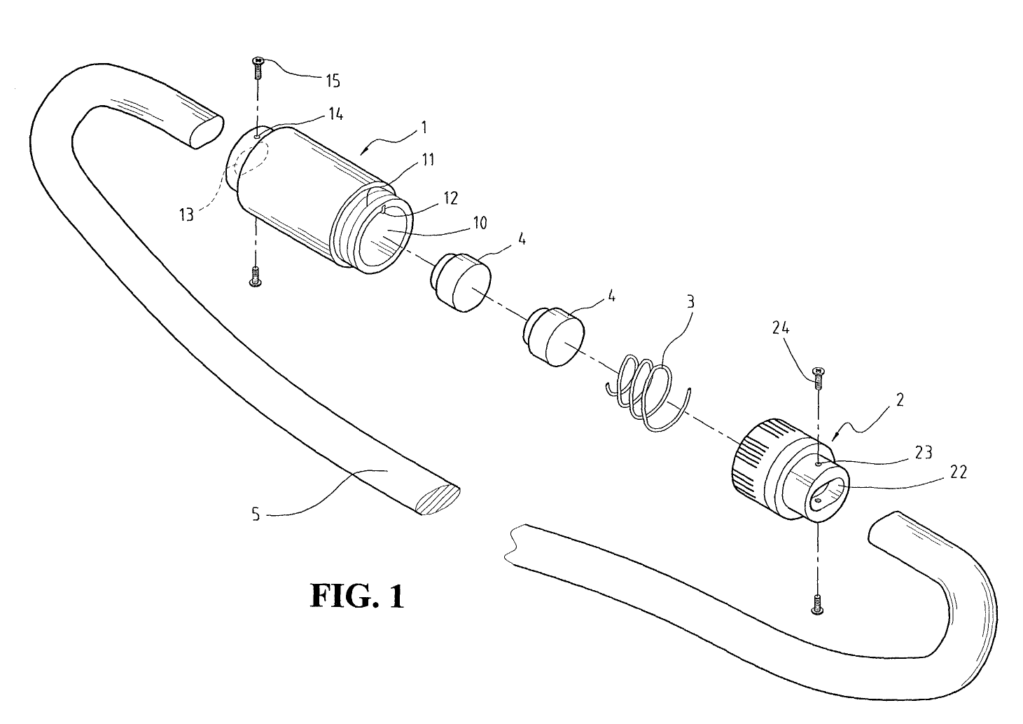

As illustrated in FIG. 1, a full circle illumination band of this invention comprises a housing 1, a cover 2, and a transparent light-guiding cord 5.

The housing 1 is provided with an inner space 10, wherein one end of the housing 1 is substantially an opening of the inner space 10, which is communicable with a hole 13 at the other end. A plurality of tapped holes 14 communicable to the hole 13 is formed in a lateral wall of the housing 1, and an outer thread 11 is arranged in an external wall of the housing 1 surrounding the opening of the inner space 10. And a power-supply unit comprising an electrically conductive unit 12 attached to the wall of the inner space 10, the cover 2, and a plurality of cells 4 disposed in the inner space 10 is arranged in the housing 1.

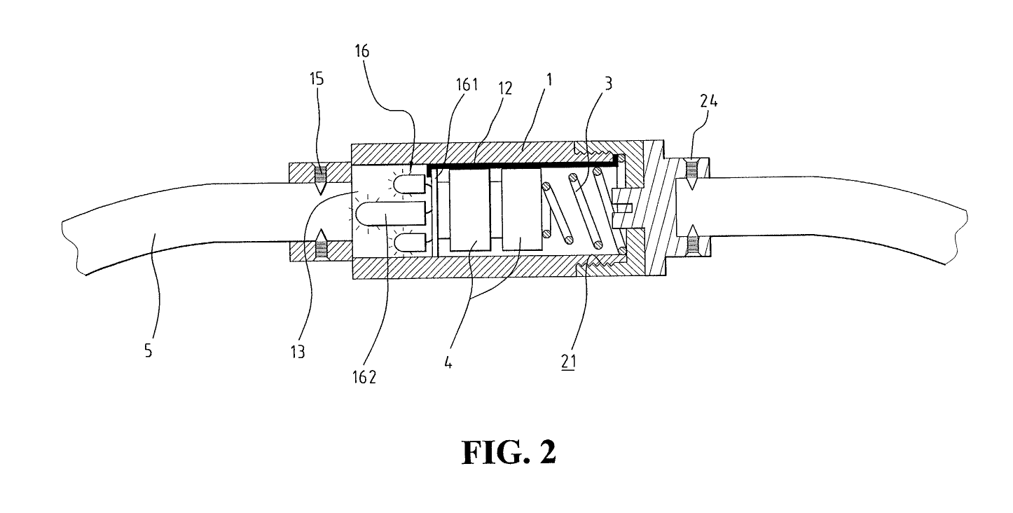

We would refer you this time to FIG. 2. As shown in FIG. 2, an illumination device 16 is disposed on a bottom face of the inner space 10 (adjacent to the hole 13), wherein a plurality of lighting elements 162 (LEDs in a preferred embodiment) is disposed on a circuit board 161 of the illumination device 16. One end of the conductive unit 12 is coupled to a contact of the circuit board 161 while the other end projecting out of the housing 1 is fixed at the opening rim of the inner space 10.

The inner wall at one end of the cover 2 is provided with an inner thread 21 (shown in FIG. 2), and the same end is further jointed with an electrically conductive spring 3, while a cavity 22 is formed at the other end which is communicable with a plurality of tapped holes 23 arranged in the lateral wall of the cover 2.

Regarding the transparent light-guiding cord 5, the solid cord applied in the optical-fiber industry is adopted in a preferred embodiment of this invention.

When assembling, the procedure starts to: firstly load the cell pack 4 in the inner space 10 of the housing 1 and meanwhile make sure one electrode of the cell pack 4 is in contact with a circuit electrode of the circuit board 161; lock the inner thread 21 of the cover 2 to the outer thread 11 of the housing 1 such that the conductive spring 3 can be buried in the inner space 10 and one end of the conductive spring 3 is in contact with the other electrode of the cell pack 4. In the case the cover 2 has not been locked tightly to the housing 1, a root portion of the conductive spring 3 will not surely contact with the conductive unit 12 projected out of the housing 1, and the lighting elements 162 wouldn't be lightened accordingly for the reason the current does not flow. On the contrary, the root portion of the conductive spring 3 will contact the conductive unit 12 firmly to form a complete current circuit to lighten the lighting elements 162 if the cover 2 is locked tightly to the housing 1. Besides, this invention may be used to control the ON/OFF operation of a power supply in cooperation with an associated vibration switch.

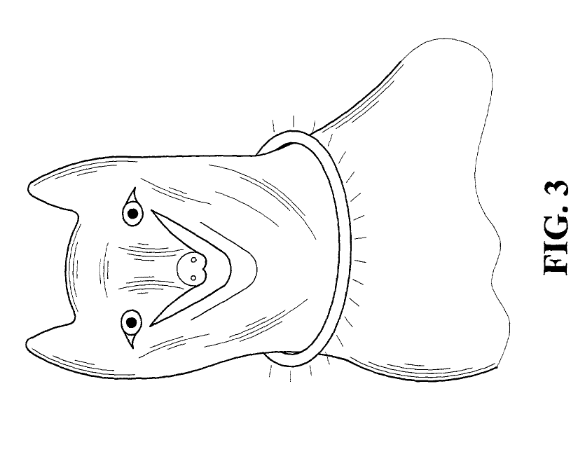

The procedure is now to: plug each of the two ends of the transparent light-guiding cord 5 in the hole 13 and the cavity 22 of the housing 1 and the cover 2 respectively; then, lock a screw 15, 24 to a tapped hole 14, 23 to further pack the light-guiding cord 5 more tightly with the screw tails to ensure that a ring-like connection of the light-guiding cord 5 with the housing 1 and the cover 2 can be secured for hitching on a pet's neck as shown in FIG. 3. In addition, any proper part of human body, such as elbow, arm, neck, etc, can be hitched with this invention just for fun. Incidentally, an outstanding advantage of this invention is that the transparent light-guiding cord 5 can be extended unlimitedly in production for cost reduction and it can be cut in length as desired.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A full circle illumination band, comprising:
a housing further comprising an illumination device and a power-supply unit; and
a transparent light-guiding cord having both ends jointed to the housing respectively; wherein a plurality of lighting elements of the illumination device is arranged at one end of the light-guiding cord to emanate light to be transmitted to the other end of the same cord.

2. The illumination band according to claim 1, wherein the power-supply unit further comprises a cover and a plurality of cells; an electrically conductive unit connected with the illumination device is disposed in the housing; one end of the conductive unit is extended out of the housing; an electrically conductive spring is attached to the cover and the cells are placed in the housing in the manner that an electrode of the cells is in contact with a contact of the illumination device; and an electric circuit is effected to cause the illumination device to emanate light when the conductive spring contacts the other electrode of the cells and the conductive unit simultaneously, otherwise, the circuit is severed and the illumination device is disabled.

3. The illumination band according to claim 2, wherein the illumination device is provided with a circuit board having a plurality of lighting elements.

4. The illumination band according to claim 3, wherein the plurality of lighting elements is the light-emitting diode (LED).

5. The illumination band according to claim 2, wherein a hole and a cavity are formed at two opposite ends of the housing respectively; a plurality of tapped holes communicable to the hole or the cavity is formed in a lateral wall of the housing for accommodating two ends of the light-guiding cord, which are then locked to the tapped holes with screws and further packed more tightly with the screw tails.

6. The illumination band according to claim 1, wherein the transparent light-guiding cord is made of a material already applied in the optical-fiber industry.
